(19) United States
(12) Patent Application Publication
(10) Pub. No.: US 2022/0203659 A1
(43) Pub. Date: Jun. 30, 2022

(54) FILM WITH AT LEAST TWO LAYERS AND METHOD FOR PRODUCING THE SAME

(71) Applicant: Brückner Maschinenbau GmbH & Co. KG, Siegsdorf (DE)

(72) Inventors: Thomas KNOCHE, Traunstein (DE); Steffen KUHNIGK, Inzell (DE); Martin ZIER, Rosenheim (DE)

(21) Appl. No.: 17/609,202

(22) PCT Filed: Apr. 30, 2020
(86) PCT No.: PCT/EP2020/062082

§ 371 Date: Nov. 5, 2021

(30) Foreign Application Priority Data
May 9, 2019 (DE) 10 2019 112 089.6

(51) Int. Cl. B32B 27/08; B32B 27/32; B32B 27/20; H01M 10/0525; H01M 50/417; H01M 50/449; B29C 48/00; B29C 48/08; B29C 48/21; B29C 48/91; B29C 71/02

(52) U.S. Cl. CPC B32B 27/08; B29L 2031/3468; B32B 27/20; H01M 10/0525; H01M 50/417; H01M 50/449; B29C 48/0018; B29C 48/022; B29C 48/08; B29C 48/21; B29C 48/91; B29C 71/02; B32B 2307/518; B32B 2250/242; B32B 2270/00; B32B 2250/40; B32B 2307/734; B32B 2255/20; B32B 2255/10; B32B 2457/10; B32B 2307/724; B32B 2307/54; B32B 2307/558; B32B 2307/72; B29C 2071/022; B29K 2023/06; B32B 27/32

(57) ABSTRACT

A biaxially-oriented film is disclosed having at least the layers (A) and (B), wherein layer (A) contains a polyethylene of a low molecular weight and layer (B) contains a polyethylene of a higher molecular weight, wherein layer (A) contains at least percent by weight of the polyethylene of low molecular weight, and layer (B) contains at least percent by weight of the polyethylene of high molecular weight and the film has a porosity in the range from 30 to 70%. The film may additionally be provided with a ceramic coating. A method for producing such a film by the Evapore process is disclosed.

### INTRODUCTION

The present invention relates to a biaxially-oriented film comprising at least the two layers (A) and (B), wherein layer (A) contains a polyethylene of a low molecular weight and layer (B) contains a polyethylene of a higher molecular weight, wherein layer (A) contains at least 50 percent by weight of the polyethylene of low molecular weight and layer (B) contains at least 50 percent by weight of the polyethylene of high molecular weight and the film has a porosity in the range from 30 to 70%. Furthermore, the film according to the invention may additionally be provided with a ceramic coating. A further subject of the present invention is a method for producing such a film by the Evapore process.

### PRIOR ART

To produce accumulators, in particular lithium-ion accumulators, separator films (battery separator films, BSF) are required, which are used in order to separate adjacent parallel anodes and

cathodes (electrodes) physically and electrically from each other. Such separator films should be thin and light and be able to prevent metallic dendrites from growing through, which may result in a short circuit. They must also be able to absorb the electrolyte and distribute it evenly over the electrode surfaces. Furthermore, they must not suppress the ion transport between the electrodes, i.e. they must ensure sufficient ion conductivity in the electrolyte. When the battery separator film is not filled, i.e. when it is not in contact with electrolyte, the ability to transport ions is expressed in a permeability to gases such as air, which is why air permeability may be used as a measure of ion conductivity. The air permeability in this case is also representative for the permeability to other gases. Furthermore, such separator films should be free of defects, such as pinholes or the like, and should be inexpensive to produce.

In the prior art, two methods among others are known with which such separator films may be produced, namely the so-called “wet process” and the “Evapore process”.

The wet process is a monolayer or multilayer casting process for producing porous separator films based on polyethylene (typically of the PE-2 type as described below). The material formulation provides for a mixture of polyethylene with mineral oil, which is homogenised by twin-screw extrusion and originally formed as a cast film. This is followed by sequential biaxial stretching. In the process, the mineral oil remains largely in the film. After the first stretching, the mineral oil is extracted using dichloromethane and the film is then dried to remove any remaining dichloromethane. This is followed, finally, by further stretching in the transverse direction. The dichloromethane/mineral oil mixture remaining in the extraction bath is treated at high cost by distillation and adsorption processes and in part fed back into the process.

In the Evapore process, instead of mineral oil, a dearomatised hydrocarbon mixture is used, which is mixed with the polyethylene in a twin-screw extrusion. While the cast film produced therefrom is sequentially biaxially stretched, the solvent passes into the gas phase. The dearomatised hydrocarbon mixture is almost completely removed from the film, collected and used to generate energy by means of incineration. The film thus produced requires no further extraction steps or poststretching. The energy generated from the afterburning may be fed back into the process. The basic principles of the process are described in detail in WO 2012/138398 A1. The production of multilayer films using the Evapore process, i.e. a coextrusion Evapore process, is hitherto unknown.

Such films produced by the wet process or the Evapore process have only limited thermal stability and can lose their mechanical integrity at high temperatures, as may occur in the event of failure of accumulators, and lead to short circuits and other failure modes. The accumulator (battery) separator films are therefore provided if needed with a porous ceramic coating to increase the temperature resistance.

Applying a ceramic coating, i.e. a coating with inorganic particles, reduces the ion conductivity of the separator films. Due to the ceramic coating, the ion conductivity of the separator films may drop to an impermissible level, which often makes it difficult to obtain a separator film having sufficient temperature resistance and sufficient ion conductivity at the same time. The coating of separator films with inorganic particles to improve properties is described in U.S. Pat. No. 6,432,586.

### OBJECT OF THE INVENTION

It was therefore the object of the present invention to provide a separator film for batteries and accumulators which has improved mechanical properties and, at the same time, acceptable ion conductivity or permeability.

Furthermore, all of the other aforementioned properties should be present in a satisfactory manner; in particular, coating with a ceramic layer should be easily possible and result in films having sufficient ion conductivity or satisfactory permeability. Furthermore, the ion conductivity of the film coated with a ceramic layer should be as similar as possible to the ion conductivity of the film not coated with a ceramic layer, and the film should have properties that are as similar as possible with regard to the coating on different sides of the film, in particular with regard to the change in ion conductivity or permeability.

### DESCRIPTION OF THE INVENTION

The present invention relates to a biaxially-oriented film, which may be used for producing separator films, which may be used in accumulators or batteries. In the present description, biaxially-oriented foils are referred to as foils, while non-oriented or monoaxially-oriented films are referred to as films. However, this is not strictly followed. The terms “film” and “foil” are to be understood as synonyms in the context of the present invention.

The present invention relates to a biaxially-oriented film comprising at least one layer (A) and at least one layer (B), wherein

layer (A) contains at least one first polyethylene (PE-1) and layer (B) contains at least one high-molecular-weight polyethylene (PE-H) which comprises at least one second polyethylene (PE-2), and wherein
layer (A) contains at least 50 percent by weight of the at least one first polyethylene (PE-1) based on the total weight of layer (A), layer (B) contains at least 50 percent by weight of the at least one high-molecular-weight polyethylene (PE-H) based on the total weight of layer (B), and the at least one high-molecular-weight polyethylene (PE-H) contains at least 50 percent by weight of the at least one second polyethylene (PE-2) based on the total weight of the at least one high-molecular-weight polyethylene (PE-H), and
wherein the at least one first polyethylene (PE-1) has a weight average molecular weight (Mw) in the range from 200,000 to 600,000 g/mol, the at least one
second polyethylene (PE-2) has a weight average molecular weight (Mw) in the range from 400,000 to 1,500,000 g/mol, and the at least one high-molecular-weight polyethylene (PE-H) and the at least one second polyethylene (PE-2) each have a weight average molecular weight, which is higher than the weight average molecular weight of the at least one first polyethylene (PE-1), and wherein
the film has a porosity in the range from 30 to 70%.

The term “polyethylene” includes homopolymers and copolymers which, in addition to ethylene, contain up to 10 percent by weight of alpha-olefins, wherein the alpha-olefins may be selected, for example, from the group consisting of propene, 1-butene and 1-hexene. However, the alpha-olefins preferably do not contain aromatic groups. Monomers containing heteroatoms are also not preferred. Homopolymers are most preferred and therefore a polyethylene homopolymer is preferably used in each case for PE-1, PE-2 and PE-3. The polyethylenes may also be selected from the group consisting of high-density polyethylene (HDPE), medium-density polyethylene, branched low-density polyethylene, high-molecular-weight polyethylene (HMW-PE) and ultra-high-molecular-weight polyethylene (UHMW-PE). HDPE (high-density polyethylene) is most preferably used for PE-1 and UHMWPE (ultra-high-molecular-weight polyethylene) for PE-2.

It has surprisingly been found that the battery separator films according to the invention have improved mechanical properties without the other properties, in particular the electrical properties, being impaired to any significant extent. The film according to the invention may, in particular, be provided with a coating of inorganic particles without the ion conductivity being excessively impaired.

Layer (A) preferably does not contain any polyethylene of a molecular weight which is greater than the molecular weight of the first polyethylene (PE-1). Layer (A) likewise preferably does not contain polypropylene.

Surprisingly, the layers of the films according to the invention adhere well to one another. No delamination of the layers was observed. The ion conductivity without a ceramic coating is surprisingly also hardly impaired by the multilayer structure. Furthermore, it has surprisingly been found that the ion conductivity of the film is not unduly impaired if a ceramic coating is applied to layer (A).

The film according to the invention therefore has improved mechanical properties and, at the same time, good ion conductivity after coating with a ceramic layer.

Both layers (A) and (B) of the film according to the invention have sufficient physical properties for a separator film. Furthermore, both have a sufficient capacity for liquids to be able to serve as a reservoir for the electrolyte. However, they differ in their mechanical properties and in their ability to maintain ion conductivity after being coated with a ceramic coating. Multilayer films that have been produced using the Evapore process are previously unknown.

Layer (A) constitutes preferably an outer layer of the film. It has the additional function of allowing the film according to the invention to be coated without the ion conductivity of the film being excessively reduced. Polymers of a lower molecular weight allow coating with inorganic particles without the ion conductivity dropping too sharply.

Layer (B) has the function of strengthening the mechanical properties of the film. Films that contain high-molecular-weight polyethylenes have better mechanical properties, such as, for example, higher strengths. The weight average molecular weight of the second polyethylene (PE-2) is preferably at least 50,000 g/mol higher than the weight average molecular weight of the first polyethylene (PE-1), particularly preferably at least 100,000 g/mol.

The information that the at least one first polyethylene (PE-1) has a weight average molecular weight (Mw) in the range from 200,000 to 600,000 g/mol, that the at least one second polyethylene (PE-2) has a weight average molecular weight (Mw) in the range from 400,000 to 1,500,000 g/mol and that the at least one second polyethylene (PE-2) each have a weight average molecular weight which is higher than the weight average molecular weight of the at least one first polyethylene (PE-1) is in the range from 400,000 to 600,000 g/mol is to be understood to mean that if PE-1 has a molecular weight in this range, the molecular weight of PE-2 must be greater than the molecular weight of PE-1 and may no longer be in the sub-range of 400,000 to 600,000 g/mol, which is equal to or less than the molecular weight of PE-1.

If a plurality of polyethylenes PE-1 are used and/or a plurality of polyethylenes PE-2 are used, then it generally applies to all polyethylenes PE-2 that they have a higher molecular weight than all polyethylenes PE-1.

The total mass of all layers (A) is preferably 5 to 50 percent by weight based on the total film. The mass of all layers (A) is particularly preferably 10 to 35 percent by weight based on the entire film and most preferably 15 to 30 percent by weight. The total mass of all layers (B) is preferably 50 to 95 percent by weight based on the entire film. The total mass of all layers (B) is particularly preferably 65 to 90 percent by weight based on the total film and most preferably 70 to 85 percent by weight. The total mass of all layers (B) has a direct influence on the mechanical properties of the film according to the invention. If the proportion of layer (B) is too low, the films often no longer meet the requirements for the mechanical properties. If the proportion of layer (A) is too low, the ion conductivity may decrease too sharply when coated with a ceramic coating. In the aforementioned ranges, the properties of the film may be adjusted and optimised as desired by the proportions of the amounts of layers (A) and (B) in the entire film. The total mass of all layers (A) is preferably 5 to 50 percent by weight and the total mass of all layers (B) is preferably 50 to 95 percent by weight, based in each case on the entire film. The total mass of all layers (A) is particularly preferably 10 to 35 percent by weight and the total mass of all layers (B) is preferably 65 to 90 percent by weight, based in each case on the entire film. The total mass of all layers (A) is most preferably 15 to 30 percent by weight and the total mass of all layers (B) is 70 to 85 percent by weight, based in each case on the entire film.

Layer (A) preferably contains at least 80 percent by weight of the at least one first polyethylene (PE-1) based on the total weight of layer (A), particularly preferably 95 percent by weight, and most preferably layer (A) consists of the least one first polyethylene. Layer (B) preferably contains at least 80 percent by weight of the at least one high-molecular-weight polyethylene (PE-H) based on the total weight of layer (B), particularly preferably at least 95 percent by weight, and most preferably layer (B) consists of the at least one high-molecular-weight polyethylene (PE-H). The at least one high-molecular-weight polyethylene (PE-H) preferably contains at least 80 percent by weight of the at least one second polyethylene (PE-2) based on the total weight of the at least one high-molecular-weight polyethylene (PE-H), particularly preferably 95 percent by weight, and most preferably the at least one high-molecular-weight polyethylene (PE-H) consists of the at least one second polyethylene (PE-2). In one particularly preferred embodiment, layer (A) consists of the at least one first polyethylene and layer (B) consists of the at least one second polyethylene.

The layers (A) preferably form outer layers of the film. In the case of films according to the invention having two outer layers (A), the total mass of the layers (A) is preferably at least 10 percent by weight based on the entire film.

The film according to the invention is preferably characterised in that it comprises at least two layers (A) and one layer (B) which are arranged in the order A-B-A. The film according to the invention is again preferably characterised in that at least one layer (A) forms an outer layer of the film. Most preferably, both outer layers of the film according to the invention are formed from layers (A).

The film according to the invention is preferably characterised in that layers (A) and (B) are directly connected to one another. This makes it possible to apply a ceramic coating on both sides of the film in order in this way to improve the temperature resistance of the film without negatively affecting the air permeability. The film according to the invention is most preferably characterised in that it consists of two layers (A) and one layer (B) which are arranged in the order A-B-A. Such a film contains no further components and is therefore easy and inexpensive to produce and the thickness, conductivity and other properties are not impaired by additional layers.

The film according to the invention is preferably characterised in that the first polyethylene (PE-1) has a weight average molecular weight (Mw) in the range from 200,000 to 450,000 g/mol and the second polyethylene (PE-2) has a weight average molecular weight (Mw) in the range from 500,000 to 1,500,000 g/mol. With such a composition it may be achieved to a particular extent that, on the one hand, the ion conductivity is only slightly impaired after the coating of layer (A) or layers (A) with a ceramic coating and, on the other hand, the film is imparted sufficient mechanical properties by layer (B).

Layers (A) and (B) of the film according to the invention may each contain additives in addition to the first polyethylene (PE-1) or the second polyethylene (PE-2) and the third polyethylene (PE-3). The additives may be selected, for example, from the group consisting of polymers, fillers, in particular those containing nanoparticles, thermal stabilisers, antistatic agents, colorants, antioxidants and stabilisers. Such additives may improve the film properties. The polymers may be selected, for example, from the group consisting of polypropylene and polybutylene. The polymers may be used to improve the mechanical and thermal strengths of the film. Layers (A) and (B) may each comprise up to 50 percent by weight of additives based on the total weight of the respective layer. With the exception of the fillers and the polymers, however, these additives are preferably contained in an amount of 20 percent by weight or less and particularly preferably in an amount of 10 percent by weight or less. A film according to the invention is particularly preferred in which at least one layer (A) contains up to 50 percent by weight, in particular preferably up to 30 percent by weight of fillers, based on the total weight of this layer (A). A film according to the invention is very particularly preferred in which all layers (A) contain up to 50 percent by weight, in particular preferably up to 30 percent by weight of fillers, based on the total weight of the respective layer (A).

The film according to the invention is preferably characterised in that the at least one high-molecular-weight polyethylene (PE-H) of layer (B) of the film according to the invention contains at least a third polyethylene (PE-3) which has a higher average molecular weight than the second polyethylene (PE-2). This allows the mechanical properties of the film to be further influenced in a targeted manner. Furthermore, it is preferred that the third polyethylene (PE-3) has a weight average molecular weight (Mw) in the range from 1,000,000 to 6,000,000 g/mol. The weight average molecular weight of the third polyethylene (PE-3) is preferably at least 100,000 g/mol higher than the weight average molecular weight of the second polyethylene (PE-2), particularly preferably at least 200,000 g/mol.

Furthermore, the film according to the invention is preferably characterised in that the first polyethylene (PE-1) has a weight average molecular weight (Mw) in the range from 200,000 to 450,000 g/mol and the second polyethylene (PE-2) has a weight average molecular weight (Mw) in the range from 500,000 to 900,000 g/mol. This applies in particular to films that contain PE-3 in layer (B). The film according to the invention is most preferably characterised in that the first polyethylene (PE-1) has a weight average molecular weight (Mw) in the range from 200,000 to 450,000 g/mol and the second polyethylene (PE-2) has a weight average molecular weight (Mw) in the range from 500,000 to 900,000 g/mol and third polyethylene (PE-3) has a weight average molecular weight (Mw) in the range from 1,000,000 to 6,000,000 g/mol. The third polyethylene is preferably used in an amount of up to 50 percent by weight, particularly preferably in an amount in the range from 1 to 30 percent by weight and most preferably in an amount in the range from 5 to 25 percent by weight based on the total mass of the at least one high-molecular-weight polyethylene (PE-H).

The addition of fillers to the film according to the invention represents an interesting option for adjusting the porosity and other properties of the layers of the film in a targeted manner. Nanoparticles are preferably used as fillers. Nanoparticles are understood in the context of the invention to mean particles having a particle size of 1 μm or less, the measurement of particle sizes being carried out by laser diffraction particle size analysis. By forming cavities in the polymer matrix, nanoparticles are able to support the pore formation process during stretching and to create an open-pored surface. Fillers and in particular fillers in the form of nanoparticles may be selected, for example, from the group consisting of CaC0₃, Al₂0₃, A100H Si0₂ and mullite. A100H is particularly preferred.

Antistatic agents reduce the tendency towards static charging and sparking, thus improving explosion protection, and are helpful in ensuring a safe operation of the system.

The film according to the invention may contain fillers, but does not have to contain fillers. If the film according to the invention contains fillers, it preferably contains up to 50 percent by weight of fillers and particularly preferably 10 to 50 percent by weight of fillers, based in each case on the weight of the entire film. The film according to the invention particularly preferably contains up to 50 percent by weight of nanoparticles, and most preferably it contains 10 to 50 percent by weight of nanoparticles, based in each case on the total weight of the entire film.

The film according to the invention particularly preferably contains up to 50 percent by weight of fillers in layer (A), based on the total weight of layer (A), very particularly preferably 10 to 50 percent by weight. The film according to the invention very particularly preferably contains up to 50 percent by weight of nanoparticles in layer (A), based on the total weight of layer (A), very particularly preferably 10 to 50 percent by weight.

In the film according to the invention, both layer (A) and layer (B) may have a porosity in the range from 30 to 70% and the porosity of layer (A) and the porosity of layer (B) may be the same or different. The porosity of layer (B) is preferably lower than that of layer (A) because this

improves overall the mechanical properties of layer (B) and of the film. The porosity of layer (B) is particularly preferably at least 5% lower than the porosity of layer (A) and most preferably the porosity of layer (B) is at least 8% lower than the porosity of layer (B).

The total porosity of the film according to the invention is particularly preferably in the range from 35 to 60%, very particularly preferably in the range from 40 to 60% and most preferably in the range from 40 to 55%. Such a porosity allows an adequate balance between the mechanical strength of the film on the one hand and the capacity for the electrolyte, the ionic conductivity and the air permeability on the other hand. The porosity of layer (A) of the film according to the invention is preferably in a range from 35 to 70%, particularly preferably in a range from 40 to 60%, very particularly preferably in a range from 40 to 60% and most preferably in a range from 40 to 55%. The porosity of layer (B) of the film according to the invention is preferably in a range from 30 to 65%, particularly preferably in a range from 35 to 55%, very particularly preferably in a range from 40 to 55% and most preferably in a range from 40 to 50%.

Films according to the invention are also preferred in which the porosity of layer (A) of the film according to the invention is in a range from 35 to 70% and the porosity of layer (B) of the film according to the invention is in a range of 30 to 65% and the porosity of layer (B) is at least 5% lower than the porosity of film (A). Films according to the invention are particularly preferred in which the porosity of layer (A) of the film according to the invention is in a range from 40 to 60% and the porosity of layer (B) of the film according to the invention is in a range from 35 to 55% and the porosity of layer (B) is at least 5% lower than the porosity of film (A). Films according to the invention are very particularly preferred in which the porosity of layer (A) of the film according to the invention is in a range from 45 to 60% and the porosity of layer (B) of the film according to the invention is in a range from 40 to 55% and the porosity of layer (B) is at least 5% lower than the porosity of film (A). Films according to the invention are most preferred in which the porosity of layer (A) of the film according to the invention is in a range from 45 to 55% and the porosity of layer (B) of the film according to the invention is in a range from 40 to 50% and the porosity of layer (B) is at least 5% lower than the porosity of film (A). Finally, among the aforementioned embodiments according to the invention, those in which the porosity of layer (B) is at least 8% lower than the porosity of film (A) are preferred.

The thickness of the film according to the invention is usually in a range from 3 to 50 μm, preferably in a range from 5 to 30 μm, particularly preferably in a range from 5 to 20 μm. The thickness of the films according to the invention is most preferably in the range from 5 to 16 μm. Films having low thicknesses are inexpensive and light. If the thickness is too low, then the mechanical properties and thus also the processability are insufficient. If it is too high, the processability during production and further processing are also insufficient.

As a rule, the proportion of the thickness of all layers (A) of the film according to the invention is in the range from 5 to 50% and the proportion of all layers (B) is in the range from 50 to 95%, each based on the total thickness of layers (A) and (B) of the film. The proportion of the thickness of all layers (A) of the film according to the invention is particularly preferably in the range from 10 to 35% and the proportion of all layers (B) is in the range from 65 to 90%. The proportion of the thickness of all layers (A) of the film according to the invention is very particularly preferably in the range from 15 to 30% and the proportion of all layers (B) is in the range from 70 to 85%. In films with such proportions, both layers are able to perform their tasks in a satisfactory manner. Layer (B) imparts good mechanical properties to the film and layer (A) allows the films to be coated with inorganic particles without impairing the ion conductivity too strongly.

One very particularly preferred embodiment of the film according to the invention involves a film which is characterised in that at least one layer (A) forms an outer layer of the film, layer (B) contains at least 80 percent by weight of the at least one high-molecular-weight polyethylene (PE-H) based on the total weight of layer (B), the total mass of all layers (A) is 5 to 50 percent by weight and the total mass of all layers (B) is 50 to 95 percent by weight, in each case based on the entire film, and the thickness of the film is in a range from 3 to 50 μm.

One very particularly preferred embodiment of the film according to the invention involves a film which is characterised in that at least one layer (A) forms an outer layer of the film, layer (B) contains at least 80 percent by weight of the at least one high-molecular-weight polyethylene (PE-H) based on the total weight of layer (B), the total mass of all layers (A) is 10 to 35 percent by weight and the total mass of all layers (B) is 65 to 90 percent by weight, in each case based on the entire film, and the thickness of the film is in a range from 3 to 50 μm.

The film according to the invention is particularly preferably characterised in that it has at least one ceramic coating which is directly connected to the surface of at least one layer (A). The film according to the invention most preferably consists of two layers (A) and one layer (B), the layers being arranged in the order A-B-A, the layers (A) forming the outer layers of the film, and is characterised in that both layers (A) have a ceramic coating that is directly connected to the surfaces of the layers (A). Such ceramic layers are suitable in a storage battery in which the films are used to separate the cathode and the anode from one another, to prevent metallic dendrites from growing through, which may result in a short circuit.

In the context of this patent application, a ceramic coating is a coating having ceramic particles. Preferred coatings are described in U.S. Pat. No. 6,432,586 B1. All of the coatings disclosed there are suitable for the present invention. Coatings which contain inorganic particles in a matrix material are particularly preferred. The matrix material may be, for example, polymers and/or binders. The particle size of the inorganic particles is preferably in the range from 0.005 to 10 μm and particularly preferably in the range from 0.05 to 3 μm, measured by a laser diffraction method. The inorganic particles are preferably selected from the group consisting of SiO₂, Al₂O₃, CaCO₃, TiO₂, SiS₂ and SiPO₄. They are particularly preferably selected from the group consisting of SiO₂, Al₂O₃ and CaCO₃. The matrix material is preferably selected from the group consisting of polyethylene oxide, polyvinylidene fluoride, polytetrafluoroethylene, polyurethane, polyacrylonitrile, polymethyl methacrylate, polytetraethylene glycol diacrylate, copolymers thereof and mixtures thereof. The matrix material is particularly preferably selected from the group consisting of polyacrylate polymer or polyvinylidene fluoride, copolymers thereof and mixtures thereof. The coatings according to the invention preferably contain between 20 to 95 percent by weight of the inorganic particles and 5 to 80 percent by weight of the matrix material. The thickness of the ceramic layer is preferably in the range from 0.05 to 10 μm and particularly preferably in the range from 0.5 to 5 μm, even more preferably in the range from 1 to 5 μm and most preferably in the range from 2 to 4 μm.

In one particularly preferred embodiment, the coating has a layer thickness of 0.5 to 5 μm and the particle size of the inorganic particles is in the range from 0.05 to 3 μm. In one very particularly preferred embodiment, the coating has a layer thickness of 0.5 to 5 μm, the particle size of the inorganic particles is in the range from 0.05 to 3 μm, the inorganic particles are selected from the group consisting of Si0₂, Al₂0₃, CaC0₃, Ti0₂, SiS₂ and SiPCg and the matrix material is selected from the group consisting of polyethylene oxide, polyvinylidene fluoride, polytetrafluoroethylene, polyurethane, polyacrylonitrile, polymethyl methacrylate, polytetraethylene glycol diacrylate, copolymers and mixtures thereof.

The ceramic layers prevent dendrites from growing through, but also reduce the ion conductivity of the separator films.

The films according to the invention are distinguished by the fact that the coating of layer (A) with a ceramic layer results in only a very slight reduction in the ion conductivity of the film according to the invention. Air permeability may serves as a measure of

the ion conductivity. Films according to the invention are preferred in which the decrease in air permeability with one-sided coating (DA) is less than or equal to 100 s/100 ml, particularly preferably less than or equal to 50 s/100 ml and most preferably less than or equal to 25 s/100 ml, with
L0: Air permeability of the film without coating in s/100 ml
L1: Air permeability of the film coated on one side on a layer (A) in s/100 ml
DA: Absolute value of the difference L1−L0 (DA=L1−L0)

In other words, the difference (DA) between the air permeability of the film according to the invention without a coating (L0) and the air permeability of the film according to the invention with only one coating on a layer (A) with a ceramic layer (LI) is preferably 50 s/100 ml or less, particularly preferably 30 s/100 ml or less. The permeability of the film in this case decreases as a result of the coating.

Furthermore, in the case of films according to the invention in which both surfaces are formed by a layer (A), both sides of the film are approximately equally suitable for coating with a ceramic layer. This means that the coating on the one side of the film results in a reduction DA in the ion conductivity or permeability that is approximately the same as the coating on the other side of the film (DB). This is an important property that makes it possible to use the same film for producing single-sided coated

films as well as for coating double-sided coated films.

Films according to the invention are preferred which are characterised in that the difference D of the decreases in air permeability is less than or equal to 25 s/100 ml, particularly preferably less than or equal to 15 s/100 ml, with
L0, LI and DA as defined above.
L2: Air permeability of the film coated on one side, which is coated on the other side of the film than LI in s/100 ml.
DB: Absolute value of the difference L2−L0 (DB=L2−L0)
D: Absolute value of the difference DA−DB (D=|DA−DB|)

In other words, films according to the invention are preferred in which the difference (D) in the reduction in air permeability when one side of the film (DA) according to the invention is coated with a ceramic layer and in the reduction in air permeability when the other side of the film according to the invention is coated with a ceramic layer Layer (DB) is not more than 25 s/100 ml, particularly preferably not more than

15 s/100 ml. Surprisingly, films which consist of only one layer (B) do not have this property.

The slight reduction in air permeability and the slight difference in the coating on the different sides of the film are a result of the multilayer structure of the film and the different molecular weights of the polyethylenes PE-1 on the one hand and PE-2 and PE-3 on the other hand.

Films according to the invention in which DA is less than or equal to 100 s/100 ml and D is less than or equal to 50 s/100 ml are very particularly suitable for commercial use, and most suitable are films according to the invention in which DA is less than or equal to 50 s/100 ml and D is less than or equal to 25 s/100 ml.

Another aspect of the present invention is a battery separator film (BSF) comprising a film according to the invention as described herein.

Another aspect of the present invention is also a lithium ion battery comprising a film according to the invention as described herein.

Another aspect of the present invention relates to a method for producing the biaxially-oriented film according to the invention. Accordingly, the present invention relates to a method for producing a film according to the invention, comprising the steps of:
providing a first polyethylene (PE-1) which has a weight average molecular weight (Mw) in the range from 200,000 to 600,000 g/mol;
providing a second polyethylene (PE-2) which has a weight average molecular weight (Mw) of 400,000 to 1,500,000 g/mol, the weight average molecular weight of the second polyethylene (PE-2) being higher than that of the first polyethylene (PE-1);
providing a first fluid (fluid 1) having a boiling point of 135 to 300° C.;
providing a second fluid (fluid 2) having a boiling point of 135 to 300° C.;
melting the first polyethylene (PE-1) and mixing the first fluid (fluid 1) with the melted first polyethylene (PE-1) to obtain a first mixture comprising 30 to 70 percent by weight of the first fluid (fluid 1), based on the total mass of the first mixture;
melting the second polyethylene (PE-2) and mixing the second fluid (fluid 2) with the melted second polyethylene (PE-2) to obtain a second mixture comprising 30 to 70 percent by weight of the second fluid (fluid 2), based on the total mass of the second mixture;
coextruding the mixtures obtained in this way by means of a multiple slot die to produce a multilayer melt, the first mixture forming at least one layer (A) and the second mixture forming at least one layer (B);
cooling the resulting multilayer melt to form a film (cast film);
stretching the resulting film in the longitudinal direction (MD);
carrying out a heat treatment (annealing);
stretching the longitudinally stretched film thus obtained in the transverse direction (TD);
carrying out a heat treatment (annealing), whereby the fluids still contained in the film pass into the gas phase.

The method according to the invention is a development of the Evapore method.

In the present method, two extruders independent of one another may be used to melt and homogenise two different formulations. For example, single-screw extruders or twin-screw extruders may be used for melting and extruding the polymers. Twin-screw extruders are preferably used. One extruder (extruder A) may be used to produce the homogeneous mixture for layer (A) based on PE-1 and a second extruder (extruder B) may be used to produce the homogeneous mixture for layer (B) based on PE-2.

Extruder A in this case is charged with PE-1, fluid 1 and, optionally, with additives. The polymer may be metered with the aid of metering scales. The fluid is preferably metered via injection valves directly into the extruder at a position at which the polymer has already melted. Fluid 1 and polymer are then mixed to form a single-phase melt. This can be done in the further extruder section.

The extruder B used is charged with powdery PE-2, fluid 2 and, optionally, with additives. The rest of the procedure is the same as for extruder A.

The melts from extruder A and extruder B are preferably merged in multiple slot dies to form a layer structure. In the case of the production of a film with an A-B-A structure, the melts are preferably merged in a triple slot die to form an A-B-A structure.

The temperature of the melt when it emerges from the nozzle is preferably in the range from 120 to 210° C. and particularly preferably in the range from 150-190° C.

The melt emerging from the nozzle is cooled and solidified in a known manner, which creates the so-called cast film. Cooling may take place by a means selected from the group consisting of at least one cooled roller and at least one water bath or a combination thereof. A combination of one or more cooled rollers and a water bath is particularly preferred. The temperatures of the roller(s) and the water bath are preferably in the range from 10 to 80° C. Instead of a water bath, any other liquid that is suitable for cooling the film may also be used. The first fluid (fluid 1) and the second fluid 2 (fluid 2) may also be used as cooling liquids. In this case, adequate fire and explosion protection measures should be taken.

The take-off speed is preferably in the range from 4 to 10 m/min and, in the case of smaller systems, in the range from 1 to 5 m/min. The thickness of the film produced is preferably in the range from 400 to 800 μm after cooling. After cooling, at least 50 percent by weight of the fluids originally used are still present in the film.

The application of the melt to the cooling roller may be supported by a so-called air knife. The thickness of the cast film is preferably in the range from 400-800 μm.

The values given above for the molecular weights of the polyethylenes for the film according to the invention also apply to the method according to the invention. A third polyethylene (PE-3), if used, is melted together with the second polyethylene and the resulting mixture is mixed with the second fluid. Additives, if used, are melted together with the first polyethylene and/or together with the second polyethylene and the mixture thus formed is mixed with the corresponding fluid.

In the method according to the invention, polyethylenes are preferably used which have a crystallinity of at least 30%. This applies to the first polyethylene (PE-1), the second polyethylene (PE-2) and, if used, also to the third polyethylene (PE-3).

The fluids are preferably liquids under normal conditions, i.e. at 25° C. and 1013 hPa. They preferably have a boiling point in the range from 100 to 300° C. and particularly preferably in the range from 150 to 250° C. Furthermore, the fluids preferably have a vapour pressure in the range from 1 to 50 mm Hg (133 to 6666 Pa) at 70° C. This makes it easier to evaporate the fluids during the production of the film. The fluids are preferably organic liquids which, apart from oxygen, include no heteroatoms and contain no aromatic groups. They are most preferably alkanes or mixtures thereof. If the fluids have boiling ranges rather than boiling points, it is assumed for the present application that the upper end (the highest temperature) of the boiling range is the boiling point of the fluid. The same fluid is preferably used for fluid 1 and fluid 2.

The film is stretched monoaxially in the longitudinal direction (MD) in a manner known per se. The total stretch ratio in the longitudinal direction is between 5 and 9 and the stretching may take place in one or more steps. The stretching temperature is preferably in the range from 80 to 125° C. and particularly preferably in the range from 95 to 110° C. After the stretching in the longitudinal direction, a heat treatment is carried out. The temperature during the heat treatment (annealing) is preferably in the range from 85 to 125° C. and particularly preferably in the range from 100 to 110° C. The thickness of the film stretched in the longitudinal direction is preferably in the range from 50 to 150 μm.

It is further preferred that after stretching in the longitudinal direction and the subsequent heat treatment, the film still contains more than 50 percent by weight of the total mass of the first and second fluids originally used.

Furthermore, it is preferred that during the heat treatment, after the stretching in the longitudinal direction, a relaxation of the film to an extent of up to 5% of the stretching ratio in the longitudinal direction is carried out. For example, with a stretch ratio in the longitudinal direction of 7 and a relaxation of 5%, the film is relaxed in the longitudinal direction in such a way that the stretch ratio in the longitudinal direction drops to 7−(7*0.05)=7−0.35=6.65.

The film is stretched monoaxially in the transverse direction (TD) in a manner known per se. The stretch ratio is preferably in the range of 5 and 9. The temperature during stretching in the transverse direction is preferably in the range from 50 to 150° C. and particularly preferably in the range from 50 to 90° C. After stretching, the film is subjected to a heat treatment, relaxed and heat-set.

It is further preferred that during the heat treatment after the stretching in the longitudinal direction, a relaxation of the film to an extent of 5 to 10% of the stretching ratio in the transverse direction is carried out. For example, with a stretch ratio in the transverse direction in this case of 7 and a relaxation of 10%, the film is relaxed in the transverse direction in such a way that the stretch ratio in the transverse direction drops to 7−0.7=6.3.

The temperature during the heat treatment (annealing) after the stretching in the transverse direction is preferably in the range from 110 to 160° C. and particularly preferably in the range from 125 to 145° C. and the relaxation ratio is preferably in the range from 5 to 10%. During the stretching and heat treatment, the remaining fluids pass into the gas phase, thus leaving behind a substantially dry film.

A method according to the invention is particularly preferred, which is characterised in that the stretch ratio during stretching in the longitudinal direction is in the range from 5 to 9 and that the stretch ratio during stretching in the transverse direction is in the range from 5 to 9, and characterised in that during the heat treatment after stretching in the transverse direction (TD) a relaxation of the film in the transverse direction of 5 to 10% of the stretching ratio is carried out in the transverse direction.

The edges of the film may then be removed in a known manner and the film may be wound up with a slight winding tension.

A method for producing a film according to the invention is very particularly preferred, comprising the steps of:
providing a first polyethylene (PE-1) which has a weight average molecular weight (Mw) in the range from 200,000 to 600,000 g/mol and a crystallinity of at least 30%;
providing a second polyethylene (PE-2) which has a weight average molecular weight (Mw) of 400,000 to 1,500,000 g/mol and a crystallinity of at least 30%, the weight average molecular weight of the second polyethylene (PE-2) being higher than that of the first polyethylene (PE-1);
providing a first fluid (fluid 1) having a boiling point of 135 to 300° C.;
providing a second fluid (fluid 2) having a boiling point of 135 to 300° C.;
melting the first polyethylene (PE-1) and mixing the first fluid (fluid 1) with the melted first polyethylene (PE-1) to obtain a first mixture comprising 30 to 70 percent by weight of the first fluid (fluid 1), based on the total mass of the first mixture;
melting the second polyethylene (PE-2) and mixing the second fluid (fluid 2) with the melted second polyethylene (PE-2) to obtain a second mixture comprising 30 to 70 percent by weight of the second fluid (fluid 2), based on the total mass of the second mixture;
coextruding the mixtures by means of a multiple slot die to produce a multilayer melt, the first mixture forming at least one layer (A) and the second mixture forming at least one layer (B);
cooling the resulting multilayer melt to form a film (cast film) having a thickness of 400-800 μm;
stretching the resulting film in the longitudinal direction (MD) at a temperature of 95 to 110° C., wherein the stretch ratio in the longitudinal direction is in the range of 5 to 9 and the film after stretching in the longitudinal direction still contains more than 50 percent by weight of the originally used total mass of the first and second fluid, and the film has a thickness of 50 to 150 μm after stretching in the longitudinal direction;
carrying out a heat treatment (annealing) at a temperature in the range of 100 and 110° C., wherein the the film, after stretching in the longitudinal direction, still contains more than 50 percent by weight of the originally used total mass of the first and second fluid;
stretching the film thus obtained in the transverse direction (TD) in a stretching oven at a temperature of 50 to 90° C.,
   the stretching ratio in the transverse direction being in the range from 5 to 9;
carrying out a heat treatment at temperatures in the range from 125 to 145° C., wherein a relaxation of the film in the transverse direction of 5 to 10% of the stretching ratio is carried out in the transverse direction and wherein the fluids still contained in the film pass into the gas phase and thus a film having a layer thickness of 5 to 16 μm is obtained.

### Examples

Measuring Methods:

Thickness (mean value): DIN 53370

Air permeability and change in air permeability: ISO 5636-5

Porosity: (weighing method)

The porosity results from the ratio of the density of the film to the density of the material used according to the formulae:

$$Density of the film = \frac{Weight}{Area \cdot Thickness}$$

$$Porosity in \% = [ 1 - ( \frac{Density of the film}{Density of the material} ) ] \cdot 100$$

For this purpose, the thickness and weight of a sample with a size of 100×100 mm are measured and the sample density is determined therefrom. The material density is drawn from the data sheet of the basic raw material used and the porosity is calculated from these two values. The porosity of individual layers may be ascertained by separating the layers and measuring the porosity of only one layer.

Tensile strength: ASTM D 882

Puncture resistance: DIN EN 14477 Thermal shrinkage: (free shrinkage in the oven)

The thermal shrinkage is measured in the oven at 105° C. for 60 minutes and results from the ratio of the initial length Lₐ to the length after thermal shrinkage Lₜ. The thermal shrinkage results from the formula:

Shrinkage(105° C./60 min)=(Lₐ−Lₜ)/Lₐ×100%

For this purpose, a sample measuring 100×100 mm is placed in the oven at 105° C. for 60 minutes between two sheets of paper. After the 60 minutes have elapsed, the sample is removed from the oven and the sample length Lₜ is measured in both main directions (machine direction and transverse direction) with an accuracy of 0.5 mm.

Particle sizes are measured by particle size analysis by laser diffraction.

Materials:

The first polyethylene to be used in all tests of example 1 was Hostalen ACP 9255+ from LyondellBasell, Frankfurt am Main, Germany. This polyethylene is a high-density polyethylene (HDPE), which has a weight average molecular weight of 350,000 g/mol and a Vicat softening point of 76° C. and its highest melting point at 133° C. The second polyethylene used in all examples was Yuhwa Hiden VH035 from Korea Petrochemical Ind. Co, Ltd., Ulsan, Korea. This polyethylene is a high-density polyethylene (HDPE), which has a weight-average molecular weight of 600,000 g/mol and its highest melting point at 136° C. The third polyethylene used in tests 6 and 7 of example 1 was Yuhwa Hiden VH150 from Korea Petrochemical Ind. Co, Ltd., Ulsan, Korea. This polyethylene has a weight average molecular weight of 1,500,000 g/mol. In addition, GUR®2024 from Celanese Corporation was used as the third polyethylene in tests 8 to 11 of example 1. This polyethylene has a weight average molecular weight of 5,400,000 g/mol. Spirdane D60 from Total Chemicals is used as fluid 1 and fluid 2 in all tests. In test 5, Actilox 200 AS1 from Nabaltec AG, Schwandorf, Germany is used as an additive. This is a filler that consists of more than 99 percent by weight of AlOOH particles and has a particle size of D10 of 0.2 μm, D50 of 0.32 μm and D90 of 0.6 μm and a BET surface area of 17 m²/g.

The mass fraction of layer (A) in the total mass of the starting materials used without the fluids is 27 percent by weight in test 1 of example 1 and 20 percent by weight in all other tests of example 1. Accordingly, the mass fraction of layer (B) in the total mass of the starting materials used, excluding the fluids, is 73 percent by weight in test 1 of example 1 and 80 percent by weight in all other tests of example 1.

A commercially available aqueous suspension of Al₂O₃, which contains a polymeric acrylic-based binder, is used as the coating solution for the production of the ceramic coating. The particle size d90 is less than 2 μm. The solids content is approximately 40 percent by weight based on the total mass of the coating solution.

### Example 1: Production of the Films

Common Test Description for all Tests of Example 1:

i) Explosion Protection

As with every EVAPORE process, the process according to the invention requires special precautionary measures due to the flash point (50-70° C.) and the auto-ignition temperature (200-250° C.) of the fluids used. Both explosion protection through safe electrical equipment and an encapsulation of the relevant system components are used. Extensive, redundant suction ensures sufficient air exchange and keeps the concentration of the solvent in the ambient air below the lower explosion limit (LEL) and below the workplace limit values. This minimises the risk of fire. Additional measures ensure further protection of people and equipment in an emergency.

ii) Extrusion

Two independent twin screw extruders were used to melt and homogenise two different formulations. Extruder A is used to produce the homogeneous mixture for layer (A) based on PE-1. Extruder B is used to produce the homogeneous mixture for layer (B) based on PE-2.

Extruder A is charged with granular or powdery PE-1 and fluid 1 and, optionally, with additives. The solids and in particular the polymer are metered using one or more metering scales. The fluid is metered via injection valves directly into the extruder at a position where the polymer has already melted. The fluid and polymer are mixed in the further extruder section to form a single-phase melt.

Extruder B is supplied with powdery PE-2, fluid 2 and, optionally, with additives. The solids and in particular the polymers are metered using one or more metering scales. Fluid 2 is metered via injection valves directly into the extruder shortly after the polymer has been metered. Fluid 2 and polymer are mixed in the further extruder section to form a single-phase melt.

Both melts from extruder A and extruder B are merged in a 3-layer nozzle to form an A-B-A layer structure. The temperature of the melt when it emerges from the nozzle is between 150-185° C., the temperature of layer (A) being 150-160° C. and the

layer B temperature being 175-185° C.

The nanoparticles and the high-molecular-weight polyethylene of the PE-3 type are fed directly into the extruder via metering scales. The high-molecular-weight polyethylene is added after the second polyethylene (PE-1), but before the fluid is added.
iii) Film Casting and Film Stripping

The melt emerging from the flat nozzle is cooled and solidified, creating the so-called cast film. The cooling takes place with the aid of two cooling rollers and a water bath. The take-off speed is between 1 and 4 m/min.

iv) Longitudinal Stretching (Machine Direction)

The film is stretched monoaxially in the longitudinal direction. A heat treatment is then carried out at 100 to 110° C. After the heat treatment, at least 50 percent by weight of the amount of fluid originally used is still present in the film.

v) Transverse Stretching, Relaxation and Annealing

After stretching in the longitudinal direction, the film is stretched in the transverse direction. After stretching, the film is relaxed and heat-treated (annealing). During the stretching and heat treatment, the remaining fluid passes quantitatively into the gas phase and leaves a dry film.

Data of the Individual Tests

A total of 11 tests were carried out, the data of which are reproduced in the following tables. Table 1 below shows the types and amounts of the reagents used, insofar as they have not already been cited above.

TABLE 1

| | | Proportion | |
|---|---|---|---|
| | | of | |
| Test | Layer | Fluid | Additives |
| 1 | A | 53 | |
| | B | 66 | |
| 2 | A | 51-71 | |
| | B | 64-66 | |
| 3 | A | 50-53 | |
| | B | 60 | |
| 4 | A | 57 | |
| | B | 57 | |
| 5 | A | 57 | 50% Actilox 200 AS1 |
| | B | 55-57 | |
| 6 | A | 57 | |
| | B | 63-66 | 20% Yuhwa Hiden VH150 |
| 7 | A | 54 | |
| | B | 63 | 30% Yuhwa Hiden VH150 |
| 8 | A | 54 | |
| | B | 64 | 10% GUR ®2024 |
| 9 | A | 54 | |
| | B | 64 | 15% GUR ®2024 |
| 10 | A | 54 | |
| | B | 64 | 20% GUR ®2024 |
| 11 | A | 54 | |
| | B | 64 | 25% GUR ®2024 |
| 12 | A | 63 | |
| | B | 54 | |
| 13 | A | 63 | |
| | B | 54 | |

Explanations for Table 1: The information in the Additives column indicates the weight percentage of the specified additives in the respective layer without taking the fluid into account. For example, layer (A) of test 5 contains 50 percent by weight of the Actilox 200 AS1 filler and 50 percent by weight of the first polyethylene (PE-1) Hostalen ACP 9255+, each based on the sum of the mass of these two solids. The freshly extruded material from test 5 consists of 57 percent by weight of the Spirdane D60 fluid and 43 percent by weight of the total mass of the solids Hostalen ACP 9255+ and Actilox 200 AS1. Correspondingly, layer (B) of test 6 contains 20 percent by weight of Yuhwa Hiden VH150 and 80 percent by weight of Yuhwa Hiden VH035, each based on the sum of these two solids, and thus 100 percent by weight of the at least one high-molecular-weight polyethylene (PE-H). The same applies to test 7.

Tables 2 to 5 in the annex show the physical data of the products obtained and the parameters of the production processes.

Table 2 shows the process parameters for the production of the cast film from the melt.

Table 3 shows the process parameters for the stretching in the longitudinal direction and the subsequent heat treatment (annealing).

Table 4 shows the process parameters for the stretching in the transverse direction and the subsequent heat treatment (annealing).

### Example 2: Coating of the Films

The films were cut to approximately A4 size. The Gurley number was measured at two points on the film. The mean value of these two measurements is the value of the air permeability of the uncoated film. The piece of cut film is fixed on a coating table with a vacuum plate. Then, 2 ml of coating liquid is applied with a doctor blade at a speed of 40 mm/s over a width of 80 mm. The film is then dried in a drying cabinet at 40 to 45° C. for 2 minutes. After drying, the Gurley number is measured again at two points. The mean value ascertained therefrom is the value of the air permeability of the coated film.

Results of the Examples:

Table 5 shows the physical data of the films obtained. As can be seen, the data for the tensile strength in the longitudinal direction (MD) are noticeably higher than the values from the prior art (see Table 1 of WO 2012/138398 A1, tests #2 and #3). However, the values for the tensile strength in the transverse direction (TD) are significantly higher than in the prior art, about four times as high and of the same order of magnitude as the values in the longitudinal direction. The present films thus have significantly more advantageous mechanical properties than the films according to the prior art. It may also be seen that the change in air permeability for most films is below 15 s/100 ml and is thus well below the limit value of 25 s/100 ml. The present films are therefore significantly more suitable for further processing to form accumulator or battery separators than the films according to the prior art. Porosity, puncture resistance and thermal shrinkage are also within the desired parameters.

TABLE 2

| | Cooling roller | | | | | |
|---|---|---|---|---|---|---|
| | | No . 1 | No. 2 | Water bath | Cast film | |
| | | temperature | temperature | Temperature | Thickness | Width |
| Test | Speed [m/min] | [° C.] | [° C.] | [° C.] | [mm] | [mm] |
| 1 | 2.1 | 60.0 | 45.0 | 29.8 | 500 | 390 |
| 2.1 | 2.9 | 60.0 | 54.9 | 29.8 | 500 | 390 |
| 2.2 | 2.7 | 60.0 | 55.2 | 30.3 | 500 | 390 |
| 2.3 | 2.2 | 60.0 | 55.2 | 29.6 | 500 | 390 |
| 2.4 | 2.0 | 60.0 | 45.0 | 30.1 | 500 | 390 |
| 3.1 | 2.0 | 60.0 | 54.9 | 29.6 | 500 | 390 |
| 3.2 | 2.0 | 60.0 | 54.9 | 29.8 | 500 | 390 |
| 4.1 | 2.4 | 60.0 | 54.9 | 30.1 | 500 | 390 |
| 4.2 | 2.4 | 60.0 | 55.2 | 29.6 | 500 | 390 |
| 5.1 | 2.4 | 60.0 | 55.2 | 30.1 | 500 | 390 |
| 5.2 | 2.4 | 60.0 | 55.2 | 29.6 | 500 | 390 |
| 6 | 2.4 | 60.0 | 54.9 | 29.6 | 500 | 390 |
| 7.1 | 2.4 | 60.0 | 54.9 | 29.6 | 500 | 390 |
| 7.2 | 2.3 | 60.0 | 54.9 | 30.3 | 500 | 390 |
| 7.3 | | 60.0 | | | 500 | 390 |
| 8 | 2.2 | 60.0 | 54.9 | 30.3 | 500 | 390 |
| 9 | 2.2 | 60.0 | 54.9 | 30.3 | 500 | 390 |
| 10 | 2.2 | 60.0 | 54.9 | 30.3 | 500 | 390 |
| 11 | 2.2 | 60.0 | 54.9 | 29.6 | 500 | 390 |
| 12 | 2.0 | 60.0 | 54.9 | 31.3 | 500 | 390 |
| 13 | 2.2 | 60.0 | 44 | 31.3 | 500 | 390 |

TABLE 3

| | | | Heat treatment | | | | | |
|---|---|---|---|---|---|---|---|---|
| | | Stretching | (annealing) | | | | | Film |
| | Preheating | Zone 2-4 | Zone 5 | Zone 6 | | Speed | Film width | thickness |
| Test | Zone 1 [° C.] | [° C.] | [° C.] | [° C.] | Stretch ratio | [m/min] | [mm] | [μm] |
| 1 | 63-92 | 95-104 | 90 | 62 | 6 | 12.1 | 286.0 | 80.0 |
| 2.1 | 63-92 | 95-104 | 94 | 64 | 5.1 | 14.2 | 260.0 | 80.0 |
| 2.2 | 63-92 | 95-104 | 94 | 64 | 5.61 | 14.5 | 260.0 | 80.0 |
| 2.3 | 63-92 | 95-104 | 94 | 64 | 7.07 | 14.9 | 262.0 | 80.0 |
| 2.4 | 63-92 | 95-104 | 88 | 60 | 6.0 | 11.6 | 280.0 | 80.0 |
| 3.1 | 63-92 | 95-104 | 88 | 60 | 6.0 | 11.5 | 274.0 | 80.0 |
| 3.2 | 63-92 | 95-104 | 88 | 60 | 6.0 | 11.5 | 274.0 | 80.0 |
| 4.1 | 63-92 | 95-104 | 90 | 62 | 6.0 | 13.9 | 274.0 | 80.0 |
| 4.2 | 63-92 | 95-104 | 90 | 62 | 6.0 | 13.9 | 274.0 | 80.0 |
| 5.1 | 63-92 | 95-104 | 90 | 62 | 6.0 | 13.9 | 274.0 | 80.0 |
| 5.2 | 63-92 | 95-104 | 90 | 62 | 6.0 | 13.9 | 274.0 | 80.0 |
| 6 | 63-92 | 95-104 | 98 | 68 | 6.06 | 13.9 | 274.0 | 80.0 |
| 7.1 | 63-92 | 95-104 | 98 | 68 | 6.06 | 13.9 | 274.0 | 80.0 |
| 7.2 | 63-92 | 95-104 | 98 | 68 | 7.07 | 15.6 | 260.0 | 80.0 |
| 7.3 | | | | | | | | 80.0 |
| 8 | 63-92 | 95-104 | 94 | 64 | 7.07 | 14.9 | 260.0 | 80.0 |
| 9 | 63-92 | 95-104 | 94 | 64 | 7.07 | 14.9 | 260.0 | 80.0 |
| 10 | 63-92 | 95-104 | 94 | 64 | 7.07 | 14.9 | 260.0 | 80.0 |
| 11 | 63-92 | 95-104 | 94 | 64 | 7.07 | 14.9 | 260.0 | 80.0 |
| 12 | 63-92 | 95-104 | 94 | 64 | 7.07 | 15.2 | 260.0 | 80.0 |
| 13 | 63-92 | 95-104 | 94 | 64 | 7.07 | 14.9 | 260.0 | 80.0 |

TABLE 4

| | | | | | Heat treatment | | | |
|---|---|---|---|---|---|---|---|---|
| | Preheating | | | Stretching | (annealing) | | Cooling | |
| | Zone 1 | Zone 2 | Zone 3 | Zone 4-5 | Zone 6-7 | Zone 8 | Zone 9 | |
| Test | [° C.] | [° C.] | [° C.] | [° C.] | [° C.] | [° C.] | [° C.] | Stretch ratio |
| 1 | 58 | 58 | 58 | 73-112 | 128-132 | 56 | 50 | 6.6 |
| 2.1 | 58 | 58 | 58 | 72-112 | 128-132 | 56 | 50 | 8 |
| 2.2 | 62 | 62 | 62 | 77-112 | 128-132 | 56 | 50 | 8 |
| 2.3 | 62 | 62 | 62 | 76-112 | 128-132 | 58 | 50 | 7 |
| 2.4 | 54 | 54 | 56 | 70-112 | 128-132 | 56 | 50 | 6.8 |
| 3.1 | 54 | 54 | 56 | 70-112 | 128-132 | 56 | 50 | 7.0 |
| 3.2 | 54 | 54 | 56 | 70-113 | 128-132 | 56 | 50 | 7.0 |
| 4.1 | 56 | 56 | 58 | 72-112 | 128-132 | 56 | 50 | 7.0 |
| 4.2 | 58 | 58 | 60 | 74-112 | 128-132 | 56 | 50 | 7.0 |
| 5.1 | 60 | 60 | 62 | 76-112 | 128-132 | 57 | 50 | 7.0 |
| 5.2 | 62 | 62 | 64 | 78-112 | 128-132 | 56 | 50 | 7.0 |
| 6 | 58 | 58 | 60 | 74-112 | 128-132 | 57 | 50 | 7 |
| 7.1 | 58 | 58 | 60 | 74-112 | 128-132 | 56 | 50 | 7 |
| 7.2 | 62 | 62 | 64 | 79-112 | 128-132 | 56 | 50 | 8 |
| 7.3 | | | | | | | | |
| 8 | 58 | 58 | 58 | 72-112 | 128-132 | 56 | 50 | 8 |
| 9 | 60 | 60 | 60 | 75-112 | 128-132 | 56 | 50 | 8 |
| 10 | 60 | 60 | 60 | 74-112 | 128-132 | 56 | 50 | 8 |
| 11 | 71 | 71 | 70 | 84-112 | 128-132 | 56 | 50 | 8 |
| 12 | 60 | 60 | 60 | 65-110 | 124-132 | 56 | 50 | 8 |
| 13 | 68 | 68 | 67 | 85-112 | 124-132 | 55 | 50 | 8 |

TABLE 5

| | | | | | Tensile | | | Thermal | |
|---|---|---|---|---|---|---|---|---|---|
| | Thickness | Air | Change in air | | strength | | Puncture | shrinkage | |
| | (Mean value) | permeability | permeability | Porosity | MD | TD | strength | MD | TD |
| Test | Thickness [μm] | s/100 ml | s/100 ml | [%] | N/nm² | | [g/12 μm] | [%] | |
| 1 | 11.9 | 164 | 4 | 50 | 135 | 110 | 372 | | |
| 2.1 | 10.5 | 199 | | 40 | 158 | 149 | 369 | 5.3 | 1.8 |
| 2.2 | 11.4 | 201 | | 43 | 145 | 147 | 385 | 6.2 | 3.0 |
| 2.3 | 9.3 | 205 | | 45 | 188 | 165 | 375 | 6.8 | 7.3 |
| 2.4 | 13.2 | 123 | 2 | 54 | 124 | 110 | 354 | | |
| 3.1 | 13.0 | 188 | 9 | 48 | 147 | 143 | 414 | 5.8 | 6.5 |
| 3.2 | 13.8 | 218 | | 49 | 151 | 121 | 450 | 5.2 | 5.5 |
| 4.1 | 13.8 | 229 | | 47 | 164 | 139 | 454 | 6.5 | 6.3 |
| 4.2 | 14.5 | 186 | | 50 | 158 | 138 | 485 | 5.8 | 7.8 |
| 5.1 | 13.4 | 198 | 13 | 52 | 155 | 120 | 527 | 6.7 | 6.8 |
| 5.2 | 14.0 | 214 | 7 | 50 | 156 | 141 | 491 | 5.7 | 4.5 |
| 6 | 13.7 | 190 | | 49 | 155 | 115 | 466 | 5.8 | 6.5 |
| 7.1 | 13.1 | 201 | 14 | 49 | 173 | 132 | 492 | 6.8 | 9.2 |
| 7.2 | 11.1 | 216 | 10 | 50 | 186 | 123 | 453 | 7.7 | 12.0 |
| 7.3 | 12.0 | 187 | 25 | 53 | 192 | 108 | 442 | 6.3 | 15.8 |
| 8 | 9.3 | 585 | | 42 | | | | 7.4 | 9.1 |
| 9 | 10.8 | 466 | | 44 | | | | 8.2 | 10.8 |
| 10 | 9.7 | 868 | | 40 | | | | 8.6 | 8.5 |
| 11 | 13.6 | 261 | | 55 | 179 | 90 | 424 | 12.0 | 16.8 |
| 12 | 5.3 | 153 | | 37 | 306 | 246 | 285 | 5.5 | 6.8 |
| 13 | 7.9 | 49 | | 60 | 189 | 123 | 231 | 14.4 | 22.7 |

1. A biaxially-oriented film, comprising:
at least one layer (A) and at least one layer (B), wherein
layer (A) contains at least one first polyethylene (PE-1) and layer (B) contains at least one high-molecular-weight polyethylene (PE-H) which comprises at least one second polyethylene (PE-2), and wherein
layer (A) contains at least 50 percent by weight of the at least one first polyethylene (PE-1) based on the total weight of layer (A), layer (B) contains at least 50 percent by weight of the at least one high-molecular-weight polyethylene (PE-H) based on the total weight of layer (B), and the at least one high-molecular-weight polyethylene (PE-H) contains at least 50 percent by weight of the at least one second polyethylene (PE-2) based on the total weight of the at least one high-molecular-weight polyethylene (PE-H), and
wherein the at least one first polyethylene (PE-1) has a weight average molecular weight (Mw) in the range of 200,000 g/mol to 600,000 g/mol, the at least one second polyethylene (PE-2) has a weight average molecular weight (Mw) in the range of 400,000 g/mol to 1,500,000 g/mol, and the at least one high-molecular-weight polyethylene (PE-H) and the at least one second polyethylene (PE-2) each have a weight average molecular weight which is higher than the weight average molecular weight of the at least one first polyethylene (PE-1), and wherein the film has a porosity in the range from 30% to 70%.

2. The film according to claim 1, further comprising at least two layers (A) and one layer (B) arranged in the order A-B-A.

3. The film according to claim 1, wherein at least one layer (A) forms an outer layer of the film.

4. The film according to claim 1, wherein both outer layers of the film according to the invention are formed from layers (A).

5. The film according to claim 1, wherein the porosity of layer (A) of the film is in a range from 35 to 70% and the porosity of layer (B) of the film is in a range from 30 to 65%.

6. The film according to claim 1, wherein the proportion of the thickness of all layers (A) of the film is in the range from 5 to 50% and the proportion of all layers (B) is in the range from 50 to 95%, in each case based on the total thickness of layers (A) and (B) of the film.

7. The film according to claim 1, wherein the layer (A) contains at least 80 percent by weight, or at least 95 percent by weight and most preferably 100 percent by weight of the at least one first polyethylene (PE-1), based on the total weight of layer (A).

8. The film according to claim 1, wherein the layer (A) does not contain any polyethylene that has a molecular weight which is greater than the molecular weight of the first polyethylene (PE-1).

9. The film according to claim 1, wherein the layer (A) does not contain polypropylene.

10. The film according to claim 1, wherein the first polyethylene (PE-1) has a weight average molecular weight (Mw) in the range from 200,000 g/mol to 450,000 g/mol and the second polyethylene (PE-2) has a weight average molecular weight (Mw) in the range from 500,000 g/mol to 1,500,000 g/mol.

11. The film according to claim 1, wherein the at least one high-molecular-weight polyethylene (PE-H) additionally contains at least a third polyethylene (PE-3), which has a higher average molecular weight than the second polyethylene (PE-2).

12. The film according to claim 1, wherein the first polyethylene (PE-1) has a weight average molecular weight (Mw) in the range from 200,000 g/mol to 450,000 g/mol and the second polyethylene (PE-2) has a weight average molecular weight (Mw) in the range from 500,000 g/mol to 900,000 g/mol.

13. The film according to claim 1, wherein the at least one layer (A) forms an outer layer of the film, layer (B) contains at least 80 percent by weight of the at least one high-molecular-weight polyethylene (PE-H) based on the total weight of layer (B), the total mass of all layers (A) is 10 to 35 percent by weight and the total mass of all layers (B) is 65 to 90 percent by weight, in each case based on the entire film, and the thickness of the film is in a range from 3 μm to 50 μm.

14. The film according to claim 1, further comprising additives, which are fillers and nanoparticles.

15. The film according to claim 1, further comprising at least one ceramic coating which is directly connected to the surface of at least one layer (A).

16. A battery separator film (BSF) comprising a film according to claim 1.

17. A lithium ion battery comprising a film according to claim 1.

18. A method for producing a film according to claim 1, comprising the steps of:
providing a first polyethylene (PE-1) which has a weight average molecular weight (Mw) in the range from 200,000 g/mol to 600,000 g/mol;
providing a second polyethylene (PE-2) which has a weight average molecular weight (Mw) of 400,000 to 1,500,000 g/mol, the weight average molecular weight of the second polyethylene (PE-2) being higher than that of the first polyethylene (PE-1);
providing a first fluid (fluid 1) having a boiling point of 135 to 300° C.;
providing a second fluid (fluid 2) having a boiling point of 135° C. to 300° C.;
melting the first polyethylene (PE-1) and mixing the first fluid (fluid 1) with the melted first polyethylene (PE-1) to obtain a first mixture comprising 30 to 70 percent by weight of the first fluid (fluid 1), based on the total mass of the first mixture;
melting the second polyethylene (PE-2) and mixing the second fluid (fluid 2) with the melted second polyethylene (PE-2) to obtain a second mixture comprising 30 to 70 percent by weight of the second fluid (fluid 2), based on the total mass of the second mixture;
coextruding the mixtures obtained in this way by means of a multiple slot die to produce a multilayer melt, the first mixture forming at least one layer (A) and the second mixture forming at least one layer (B);
cooling the resulting multilayer melt to form a film (cast film);
stretching the resulting film in the longitudinal direction (MD);
carrying out a heat treatment (annealing);
stretching the longitudinally stretched film thus obtained in the transverse direction (TD);
carrying out a heat treatment, whereby the fluids still contained in the film pass into the gas phase.

19. The method according to claim 18, wherein the stretch ratio for the stretching in the longitudinal direction is in the range from 5 to 9 and in that the stretch ratio for the stretching in the transverse direction is in the range of 5 to 9, and characterised in that during the heat treatment after the stretching in the transverse direction (TD) a relaxation of the film in the transverse direction of 5% to 10% of the stretch ratio is carried out in the transverse direction.

20. The method according to claim 18, wherein during the heat treatment, after stretching in the longitudinal direction (MD), a relaxation of the film in the longitudinal direction by up to 5% of the stretching ratio is carried out in the longitudinal direction.

21. The film according to claim 1, wherein the thickness of the film is in a range from 3 μm to 50 μm, or in a range from 5 μm to 30 μm.
